(19) United States
(12) Patent Application Publication
(10) Pub. No.: US 2022/0371177 A1
(43) Pub. Date: Nov. 24, 2022

(54) VEHICLE REPAIR BOARD

(71) Applicant: Lechwe Scott Distribution, LLC, d/b/a Performance Refinish Supply, Evansville, IN (US)

(72) Inventors: Ryan Ketcham, Noblesville, IN (US); Philip Zylstra, Ontario (CA)

(21) Appl. No.: 17/747,149

(22) Filed: May 18, 2022

Related U.S. Application Data
(60) Provisional application No. 63/191,697, filed on May 21, 2021.

(51) Int. Cl. B25H 5/00; B62B 3/00; B62B 5/00; G06Q 10/00

(52) U.S. Cl. CPC B25H 5/00; B62B 3/005; B62B 5/0096; G06Q 10/20

(57) ABSTRACT

A vehicle repair board having a schematic representation of a vehicle is provided for schematically assisting vehicle part storage and organisation during repair procedures. The vehicle repair board has a plurality of fasteners for connecting tools, parts, and consumables to the board and a support structure for supporting the board in a vertical orientation.

### RELATED APPLICATION

This application claims priority from U.S. Provisional Application No. 63/191,697, filed 21 May 2021, the subject matter of which is incorporated herein by reference in its entirety.

### TECHNICAL FIELD

The present invention pertains to a vehicle repair board for schematically assisting vehicle part storage and organisation during repair procedures.

### BACKGROUND

In the collision repair industry is it common practice during repair of a vehicle that the vehicle and its parts are disassembled for the purposes of diagnostics, part replacement, and repair. During the repair procedure parts are removed and must be organized and stored such that they can be assessed, replaced, and reassembled properly once the repair is underway. During a complicated repair with many parts being removed from the vehicle the organization of removed parts can get complicated and repair shops often develop their own systems for organization, such as using envelopes, plastic bags, and containers, placed on surfaces or in larger containers available to them. Keeping track of parts and their locations can quickly become complicated, especially if there is more than one person working on the vehicle at a time.

### SUMMARY

In an aspect, alone or in combination with any other aspect, a vehicle repair board is described. A board comprises a schematic representation of a vehicle. A plurality of fasteners is provided for connecting tools, parts, and consumables to the board. A support structure is provided for supporting the board in a vertical orientation.

In an aspect, alone or in combination with any other aspect, a method of vehicle repair is described. A part is removed from a vehicle. The removed part from the vehicle is stored in an area on a board comprising a schematic representation of the vehicle that correlates to the same area of the vehicle being repaired.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a partial schematic front isometric view of a vehicle repair board and parts cart;

FIG. 2 is a front view of a vehicle schematic on a repair board;

FIG. 3 is a flowchart of vehicle disassembly and repair using the vehicle repair board; and

FIG. 4 is a vehicle schematic of the hood of a vehicle.

### DESCRIPTION OF ASPECTS OF THE DISCLOSURE

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “comprising,” “having,” “including” and “containing,” and grammatical variations thereof, are inclusive or open-ended and do not exclude additional, unrecited elements and/or method steps. The term “consisting essentially of” when used herein in connection with a composition, device, article, system, use, or method, denotes that additional elements and/or method steps may be present, but that these additions do not materially affect the manner in which the recited composition, device, article, system, method, or use functions. The term “consisting of” when used herein in connection with a composition, device, article, system, use, or method, excludes the presence of additional elements and/or method steps. A composition, device, article, system, use, or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The invention comprises, consists of, or consists essentially of the following features, in any combination.

Herein is described a vehicle repair board with a schematic or diagram of a vehicle that can be used to organise parts and products during the disassembly, diagnostics, and repair of a damaged vehicle. The vehicle repair board can also be used to be a communication tool for multiple technicians to store documents, instructions, vehicle information, insurance information, notes, tools, consumables, parts, and the like. A central workspace for the organization and storage of materials and documents relating to the repair of a vehicle ensures that materials and information is organized and effectively communicated and that all parts are accounted for during the disassembly and repair process. The vehicle repair board provides a mechanism to organise multiple pieces of a disassembled vehicle and account for the various parts as they are removed and replaced. In practice, as the vehicle is disassembled the technician can take the pieces or parts of the vehicle that have been removed and place them on the related space on the board schematic such that the removed parts or pieces can be replaced at the same location on the vehicle from which they were removed.

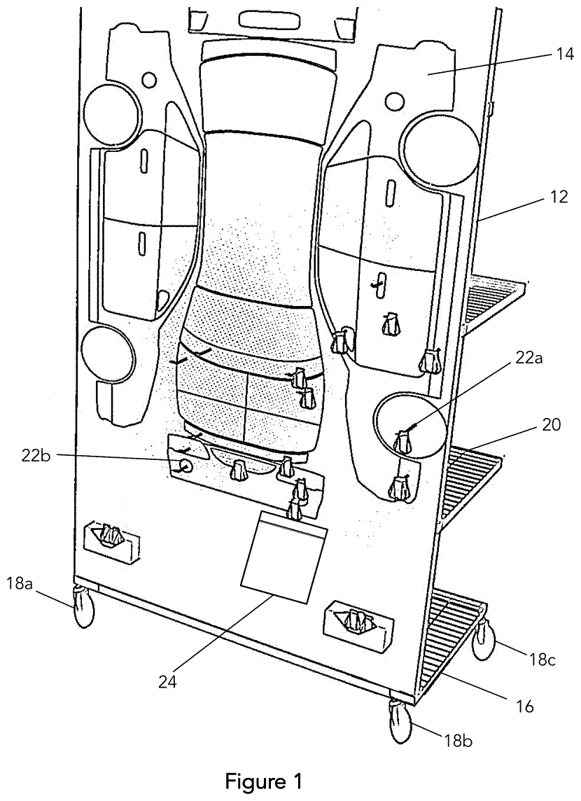

FIG. 1 is a partial schematic front isometric view of a vehicle repair board. The vehicle repair board 10 has a board 12 with a schematic representation of a vehicle supported in a vertical orientation on a support structure 16, which in this case is a parts cart. The vehicle schematic 14 is an illustration, image, photograph, or other user-perceptible representation of a vehicle or part thereof or deconstructed image thereof. The vehicle schematic 14 illustrates a section or sections of the vehicle such that areas of the vehicle undergoing maintenance or repair can be identified and parts removed from those sections can be organized accordingly on fasteners on the board at the appropriate locations.

The fasteners 22a, 22b on the repair board can be any variety of connector that can attach a part, component, or piece to the vertically supported board 12. Examples of fasteners include but are not limited to affixed hook and loop fasteners (such as Velcro®), clips, hooks, magnets, affixed containers, envelopes, or other devices. In one example, the board 12 is magnetic and magnetic fasteners can be affixed to the board 12 at adjustable locations on the board at variable locations on vehicle schematic 14. If the fasteners comprise magnets a magnetic container, bag, or other external holding device can be attached to the board 12 via the magnet. In addition, magnetic parts such as screws, ties, and other magnetic metal parts can be attached to the magnets on the board 12. In another example the board 12 can comprise hooks and/or clips affixed at various locations on vehicle schematic 14 where repairs are commonly carried out. These hooks or loops can support hanging bags, envelopes, containers, or other receptacles for holding small parts during maintenance, disassembly, and/or repair.

FIG. 1 shows the repair board with the schematic fastened to a parts cart having a support structure 16 and at least one caster wheel (three shown at 18a, 18b, 18c with a fourth wheel not visible in this view). Any desired number or type of wheel may be provided to the support structure. In this case the repair board is placed on a cart that is many cases is used to store large parts that have either been removed from the damaged vehicle or have been ordered to replace damaged large parts that will need to be replaced. The fasteners 22a, 22b provide a mechanism for hanging or temporarily fastening items, parts, small bags, envelopes or other similar parts containers 24 that can hold parts in a specific area that correlates to similar areas of the actual vehicle. The fasteners can be placed in specific areas of the vehicle diagram that correlate directly to the area of the actual vehicle where the product or parts was removed. The schematic board can also have space for storing one or more larger parts container 24, such as on one or more shelf 20 on the front or rear of the board 12.

During maintenance or repair parts or pieces are generally removed from the damaged vehicle and can be placed in the correlating space on the vehicle schematic on the repair board. Clips or fasteners such as, but not limited to, plastic clips, nuts and bolts, can be placed inside of a parts container 24 so that the technician can remember easily where the parts are to be placed upon reassembly or to inventory parts removed from the vehicle during repair. Likewise, broken or otherwise damaged clips and fasteners can be placed in the same or different parts container, which can be, for example, a colored bag with optional marking of text or color, as a means of communication to another technician, parts department or estimator, that these parts, clips, and/or fasteners are to be replaced.

Collision facilities are able to charge insurance companies for various products needed to repair a damaged vehicle back to its original state and maintaining inventory of the use of these products during a repair can enable reimbursement to the shop as well as assurance that the replacement products used are up to proper standards. These products may be, but aren't limited to, replacement clips, tapes, fasteners such as screws and bolts, lubricants, and adhesives for gluing parts for repair and reassembly. The replacement parts and materials used for the repair can be invoiced for payment from the customer or insurance provider, and the present repair board can assist with maintaining inventory and use of these products such that these can be billed to the client, defraying costs to the repair shop. In one example, the use of consumable products such as adhesives, lubricants, and sealants can be volumetrically measured by comparison of supplies before and after use at a particular vehicle. Consumables that can be measured linearly such as adhesive tapes and lubricant tapes can be accounted for by linear amount used in a repair. In this way a repair shop can organize all billable products into one space on a place where the correlating billable item from the vehicle can be organised and placed onto a correlating area of the vehicle diagram on the board for organization and in turn can be used to communicate which products need to be invoiced.

The illustrated schematic representation or diagram of all or some views of the vehicle under repair with associated storage features enables areas for storing broken or unbroken vehicle parts on the board in the area on the vehicle schematic that correlates to the same area of the actual vehicle where the part has been removed from. This enables organized removal and storage of parts such that the same parts can be easily found and replace where they were removed from during vehicle reassembly or repair. This is especially useful when more than one technician is needed to address the information on the board in order to thoroughly write an estimate for a damaged vehicle in a repair setting, or in order to assemble the vehicle back to its original state. The board can have a schematic diagram of one or all sides of a vehicle that has areas for affixing vehicle parts, tooling, or consumable products, and the fasteners or point for affixing parts, tools and consumable products can be placed on an area of the board that correlates to the area of the vehicle that is being worked on. The vehicle schematic 14 can also be on one or both sides of the board 12, and can further comprise areas for placing or hanging products or tooling that are used to repair the vehicle.

As vehicles have become more complicated the vehicle schematic board can also provide a mechanism to organise clips and fasteners as a means to easily remember where these parts are to go for reassembly. Likewise, as the repair process becomes more complicated it is useful to have a communication piece that can be edited and easily read where notes related to the repair process can be written so all technicians throughout the repair process on a specific vehicle can be aware of processes and functions of the repair. Replaced parts and materials used can thereby be easily inventoried and invoiced to the customer or insurance provider, saving costs and providing more accurate inventory to the repair shop.

The vehicle repair board can 10 also comprise multiple points at which removable parts, tools, and consumables can be affixed to indicate where the part, tool, or consumable was removed from, is to be affixed to, or is to be to be used on. The term “part(s)” as used herein refers to a piece taken off of a vehicle that is part of the original vehicle or vehicle prior to the current repair which can include, but is not limited to, clips, fasteners, brackets, body components, etc. Multiple types of items can be placed on the board as a means to remember the repair steps, or where a specific part needs to be placed for reassembly. Also, consumable products can be placed on the board that are needed as a means to properly repair the vehicle. Consumable products are often used on a vehicle for the repair process and refers to products that are used while repairing a vehicle and these may be removed after the repair or may stay on the vehicle after the repair is completed. Some consumable products used to repair the vehicle comprise, but are not limited to, glues, adhesives and tapes. Both parts and consumable products can be understood as recoverable products, or products that can be invoiced to the insurance company or customer that are used to repair the vehicle. In addition to parts, tags indicating or denoting larger components can be affixed to the board to keep track of or otherwise monitor required parts and the identification thereof. These products can also be placed on the schematic repair board as they are to be invoiced to the insurance provider or customer and may be placed in bags with markings on them or different colored bags as a means to communicate to other employees that they are to be invoiced.

The vehicle repair board 10 can optionally also have a space or tool that can be used to write information relating to the vehicle repair process, or a space where printed original equipment manufacturer (OEM) repair procedures and information can be placed where a technician can easily access the information during and after the repair procedure. These procedures and information can be provide by, for example, one or more manual, repair sheet, or in an electronic format such as on a tablet, computer, or mobile screen. Such information can include, for example, OEM repair processes, invoice identification numbers and vehicle identification numbers. Additionally, there can be provided a space for an iteration of an OEM repair procedure document that could be in the form of paper printed from a computer or a space for an electronic device or integrated electronic device where the repair procedure, vehicle repair, vehicle schematics, part schematics, and other information relating to the vehicle can be shown. Information can also be stored on an electronic device that can assist with information retrieval during the repair and invoicing process.

The vehicle schematic 14 can be an image of the whole outside of the vehicle, as shown, a part of the vehicle such as under the hood, the undercarriage of the vehicle shown from below, or a section thereof. The vehicle schematic 14 can be generalized, such as for a car, truck, van, minivan, boat, motorcycle, all-terrain vehicle, aircraft, helicopter, drone, or other vehicle, or it can be specific to a particular vehicle or vehicle type or vehicle manufacture, or drawing of a vehicle and can comprise one or more views of angles and sides of a vehicle including the components of the car such as, but not limited to, wheels, tires, doors, fenders and vehicle panels and glass. The vehicle schematic 14 can also be printed on a piece of reusable or disposable removable paper, polymer, vinyl, or other pliable surface cover, which can be attached to the board 12 as appropriate to the repair being done.

The board 12 can also have a surface coating that can be written on and where the writing can be erased, such as a white board, dry-erase board, chalk board, or other erasable surface, with the vehicle schematic 14 optionally being permanent to remain on the board after the board is erased. This enables a technician or repair person to write notes or otherwise record information on the board at the location where the note is relevant, such as an indication of damage, parts or tooling requirement, or other communication, or other administrative functions such as writing a repair work order, report, or estimate.

The board 12 can further be removed from its original state or removable from the support structure 16 and moved such that it can be supported by or affixed to a wall or other surface. The board may also be affixed permanently to a cart or administrative desk that can have further area for storage. The storage cart can be used for, but not limited to, the storage of consumable products, common clips and fasteners, repair procedure information and equipment, tools and for larger parts that have been removed from the vehicle. The board can also be removed from the original location and placed in the work area where any work on the vehicle may be taking place.

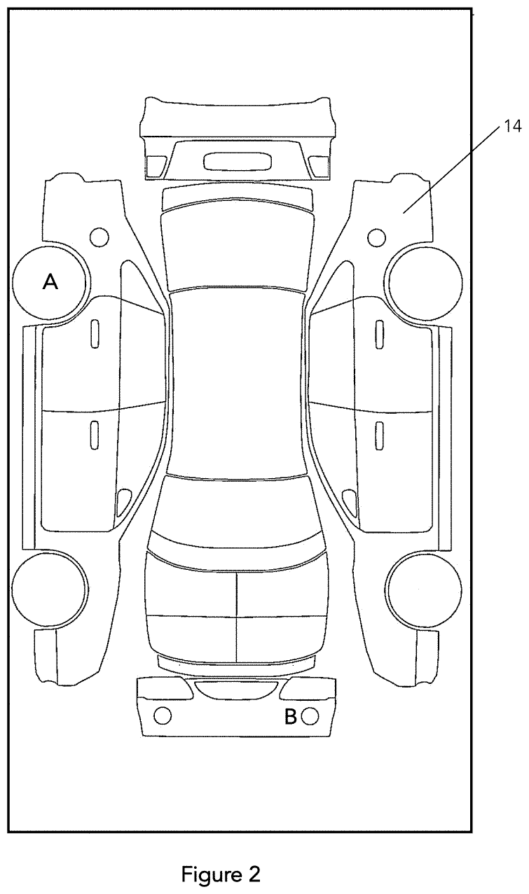

FIG. 2 is a front view of a vehicle schematic 14 on a repair board. The schematic drawing is permanent and can represent any vehicle of any nature. The board itself can be erasable such that it can be written on with erasable markers or pens where the user can mark the board specifically for the present vehicle that is being worked on. The area on the schematic that correlates to the area of the vehicle that is being worked on is a suggested area for hanging the appropriate parts. For example if the user has disassembled the vehicle wheel from the physical vehicle, the technician would then place the removed pieces on the correlating wheel A on the schematic board. Likewise, if the user removes a piece of a headlight, or the whole headlight, from the physical vehicle, they would then place the removed part on the repair board at the correlating area B on the repair board.

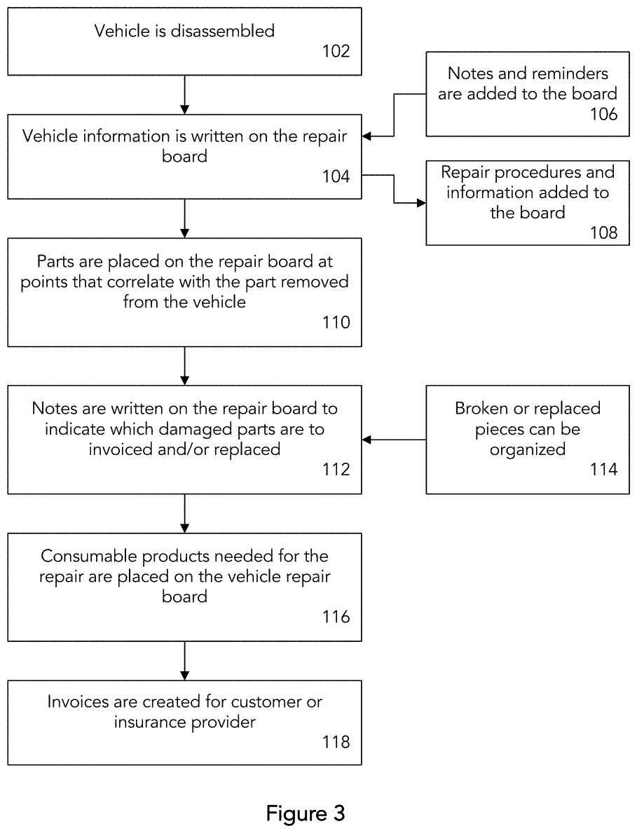

FIG. 3 is a flowchart of vehicle disassembly and repair using the schematic vehicle repair board. Prior to use of the board, the vehicle is brought into the shop. Vehicle disassembly 102 may occur at any time for the purposes of inspection, diagnostics, or repair, during which time an estimate can be written. Before a vehicle is disassembled for an estimate at a collision repair facility a technician will write relevant vehicle information on the repair board such as, but not limited to, the vehicle identification number, work order number and date of arrival. Information such as specific OEM repair procedures for specific repairs on a specific vehicle can be placed on the repair board for technician consultation. The repair procedures can be in the form of printed or written paper or on an electronic device. Likewise, repair notes and reminders can be written on the repair board that can be used as a means of communication between technicians or departments of the repair facility.

Vehicle information can be written on the repair board 104 such as, but not limited to, vehicle identification numbers, invoice numbers, job numbers and Original Manufacturer repair procedures and information. Notes and reminders can also be added to the board 106 as a means of communication from one department to another. Repair procedures for repair of specific vehicles 108 or Original Manufacturer repair procedures can also be stored on the vehicle repair board, such as in the form of storage for a computer tablet, cellular telephone, electronic device, or printed pages or manuals. Clips and fasteners removed during disassembly are then placed on the board 110 in spaces of the schematic diagram that correlate directly to the area of the vehicle where they were removed. Removed pieces of the vehicle can also be placed on areas of the repair board on the schematic diagram such as a rare or special clip or fastener that are of importance and have specific unique qualities. As the vehicle is disassembled the technician can place removed clips and fasteners or vehicle parts on the repair board in the specific area of the board directly correlated to the part that was removed on the actual vehicle 110. As the technician removes the parts, such as clips and fasteners, some may be damaged and in need of replacement. The technician will remove the broken clips and fasteners and place them in a colored container different that is different than the containers used for undamaged parts, thus indicating to a parts person or estimator that these clips and fasteners need to be replaced and invoiced. Similarly, the technician could place the broken parts in a colored bag similar to the bags used for undamaged parts and use a marker or sticker to indicate broken pieces in need of replacement. As the disassembly is done the technician will also place consumable products such as, but not limited to, adhesives and tapes that are needed for the repair of the vehicle that can be charged to the insurance company or customer, on the board in the desired area. Upon complete disassembly of the vehicle a parts person, estimator or technician can check the visual of the board and easily ascertain which parts and products are needed to be replaced and invoiced to complete the estimate. Likewise, a technician can use the placement of the items on the board as a means of communication that shows them where the parts are to be used on the actual vehicle for reassembly. Upon reassembly the technician can take the items from the specific areas on the board that correlate directly to the vehicle and easily reassemble the vehicle with minimum effort based on the layout of the repair board and the respective parts.

Notes can then be written on the board in close proximity to broken clips and fasteners as a means of communication 112, these notes could be the replacement part number or name. The broken clips and fasteners can be placed on the schematic board 114 in bags or containers similar to undamaged clips and fasteners but with a means of differentiating the bag such as, but not limited to, placing a sticker on the bag or writing on the bag with a marker or pen. Different colored bags could also be used to store broken clips and fasteners as a means of communication to other departments or technicians. Consumable products that are needed for the repair can also be placed on the vehicle repair board 116 or shelves, containers, or support structure. Consumable products such as, but not limited to, glues, adhesives, seam sealers and tapes can also be placed on bags similar to the unbroken parts that have markings on them to differentiate them from unbroken parts, or different colored bags as a means of communication to other departments or technicians. The means of communication can be used for various functions such as, but not limited to, a reason to invoice the part to the appropriate job and replacement. An inventory of all marked or different colored bags is taken and then an invoice is created for the correlating products within the bags. Once the inventory of the bags contents are taken an invoice for the contents within the bag is created and then charged to the appropriate insurance provider or customer.

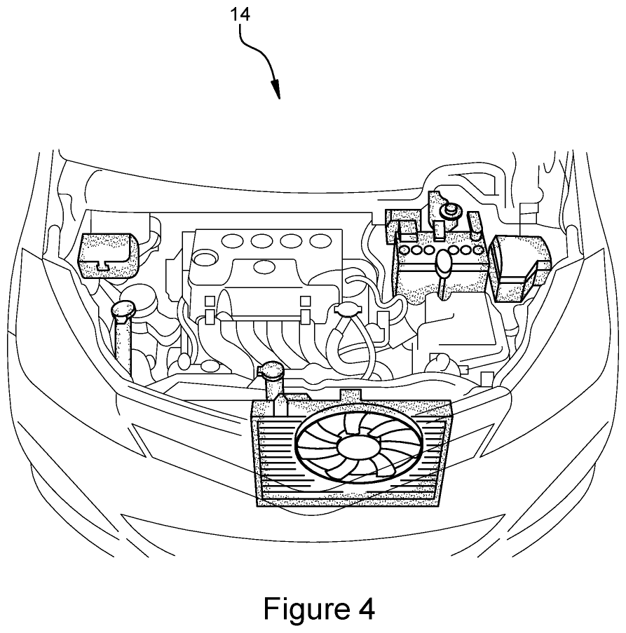

FIG. 4 is a vehicle schematic 14 of the hood of a vehicle. This vehicle schematic of the hood portion of a vehicle can be used when hood work is being done on a vehicle.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

We claim:

1. A vehicle repair board comprising:
a board comprising a schematic representation of a vehicle;
a plurality of fasteners for connecting tools, parts, and consumables to the board; and
a support structure for supporting the board in a vertical orientation.

2. The vehicle repair board of claim 1, wherein the board is at least one of a whiteboard, a dry erase board, a chalkboard, and a pliable surface cover.

3. The vehicle repair board of claim 1, further comprising at least one of an integrated electronic device and a separately provided electronic device, for storing vehicle information.

4. The vehicle repair board of claim 1, wherein the support structure is a movable cart.

5. The vehicle repair board of claim 1, wherein the support structure comprises at least one wheel.

6. The vehicle repair board of claim 1, wherein the support structure comprises at least one shelf.

7. The vehicle repair board of claim 1, wherein the board is removable from the support structure.

8. The vehicle repair board of claim 1, wherein a schematic representation of at least one portion of the vehicle is on both sides of the board.

9. A method for vehicle repair comprising:
removing a part from a vehicle; and
storing the removed part from the vehicle in an area on a board comprising a schematic representation of the vehicle that correlates to the same area of the vehicle being repaired.

10. The method of claim 9, wherein the removed part is stored in a container affixed to a fastener on the board.

11. The method of claim 10, wherein the container is coded by at least one of text and color.

12. The method of claim 10, wherein the container is at least one of an envelope, a flexible bag, and a hard sided container.

13. The method of claim 10, wherein the fastener is at least one of a hook and loop fastener, a clip, a hook, a magnet, and an adhesive.

14. The method of claim 9, further comprising recording on the board at least one of vehicle information and written information related to the repair.

15. The method of claim 14, further comprising erasing the written information from the board such that the board can be used in a subsequent vehicle repair.

16. The method of claim 9, further comprising at least one of keeping track of and invoicing new parts used in the repair.

17. The method of claim 9, further comprising at least one of keeping track of and invoicing consumables used in the repair.
